(19) United States
(12) Patent Application Publication
(10) Pub. No.: US 2004/0064690 A1
(43) Pub. Date: Apr. 1, 2004

(54) Methods for applying for crypto-keys from a network system

(76) Inventors: Xiao-Qin Yu, Shanghai (CN); Dai-Shui Ho, Taipei Hsien (TW); Shih-Kuang Tsai, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,291

(22) Filed: Oct. 1, 2002

(51) Int. Cl. H04L 9/00

(52) U.S. Cl. 713/156

(57) ABSTRACT

A method for applying for crypto-keys from a network system. The network system includes at least a user, an access point for identifying the user, and a server for generating a pair of distinct crypto-keys based on a first algorithm. The method includes using the access point to identify the user, and the server generating a pair of distinct crypto-keys based on the first algorithm and transmitting the pair of keys to the user via the access point. The method further includes the user using the pair of keys to encrypt a document and then transmitting the encrypted document to another user.

### BACKGROUND OF INVENTION

1. Field of the Invention

The invention relates to a method for applying for crypto-keys, and more particularly, to a method for applying for crypto-keys in a network system.

2. Description of the Prior Art

In recent years, along with the fast development of the Internet, some traditional trading mechanisms have already been replaced by E-Commerce, but the current E-Commerce methods still leave some room for technical improvement in order to put consumers at ease. One of the important issues is security during the trading process.

For guaranteeing the security of E-Commerce to a certain degree, the knowledge of cryptography is applied broadly in network systems. For instance, a typical ciphering system usually comprises three leading roles, which are letter-senders, letter-acceptors, and the hackers in the network system. The letter-senders will first make use of an encryption module and crypto-keys to encrypt plain text into symbols that cannot be recognized. These symbols are the so-called ciphered text. Afterwards, the letter-senders make use of the Public Channel to deliver the ciphered text to the letter-accepters. After letter-accepters receive the ciphered text, they can decrypt the ciphered text into a plain text by using the encryption module and the crypto-keys. The hackers in the ciphering system cast covetous eyes on the ciphered text in the Public Channel.

In the earlier ciphering system, the encryption-keys and decryption-keys are the same pair of crypto-keys, and are kept by the letter-senders and the letter-accepters respectively. Please refer to FIG. 1. FIG. 1 is a schematic diagram showing the transmission of a document 12 making use of a private key system 10. A first port 18 of the private key system 10 comprises an encryption module 14 for encrypting the document and a decryption module 16 for decrypting the document. A second port 28 of the private key system 10 also comprises an encryption module 24 and a decryption module 26. The user can make use of the private key system 10 to complete the secret transmission of the document 12 when the user would like to deliver the document 12 from the first port 18 to the second port 28 without revealing the contents of the document 12 to others. The methods for confidentially transmitting the document 12 by the private key system 10 are described as follows: First, the user makes use of the encryption module 14 to encrypt the document 12 into a ciphered text 20 with a crypto-key. Then the user makes use of a Public Channel 19 to transmit the ciphered text 20 to the second port 28. After the ciphered text 20 is transmitted to the second port 28, the decryption module 26 will decrypt the ciphered text 20 with the crypto-key, and the user at the second port 28 can realize the contents of the document 12. Likewise, when the user at the first port 18 receives the ciphered text encrypted with the crypto-key that was transmitted from the second port 28, the user at the first port 18 can make use of the decryption module 16 to convert the ciphered text into a plain text with the crypto-key. In the process of transmission of the ciphered text, if a hacker in the network would like to cut and take the ciphered text 20, the hacker cannot readout the concealed contents of the ciphered text 20 whether the hacker obtains the ciphered text 20 or not since the hacker does not have the crypto-key. Therefore, the private key system 10 can really provide the function of secretly delivering documents.

However, there are still some defects in the private key system 10. First, the users at the first port 18 and the second port 28 have to remember the crypto-key anytime. If one forgets, both parties cannot make use of the crypto-key to transmit the ciphered text 20. Second, only the users at the first port 18 and the second port 28 own the crypto-key, that is, the users at the first port 18 and the second port 28 cannot make use of the crypto-keys to transmit the ciphered text to others. Therefore, the private key system 10 is gradually unpopular, and the public key system starts to take its place.

Please refer to FIG. 2. FIG. 2 is a schematic diagram showing how to make use of a public key system 30 to transmit a document 32. A first port 38 of the public key system 30 comprises an encrypting module 34 to encrypt the document and a decryption module 36 to decrypt the document. A second port 48 of the public key system 30 also comprises an encrypting module 44 and a decryption module 46. Although the public key system 30 still makes use of a pair of crypto-keys to encrypt the transmitted document and to decrypt the received document, the public key system 30 is different from the private key system 10. The difference is that the two keys of the pair of crypto-keys are distinct, one for public key 35 and another for private key 37. The public key 35 and the private key 37 correspond to each other. When the user at the first port 38 would like to deliver the document 32 from the first port 38 to the second port 48, the user will first transmit the public key 35 from the first port 38 to the second port 48, and then the user can make use of the encryption module 34 to encrypt the document 32 to the ciphered text 40 with the private key 37. Finally the user can make use of a Public Channel 39 to deliver the ciphered text 40 to the second port 48. After the ciphered text 40 is transmitted to the second port 48, the user can make use of the decryption module 46 to decrypt the ciphered text 40 with the public key 38 previously delivered from the first port 35. Thus the user at the second port 48 will know the contents of the document 32. Likewise, when the user at the second port 48 would like to deliver another document 42 from the second port 48 to the first port 38, the user can make use of the encryption module 44 to encrypt the document 42 into a ciphered text 41 with the public key 37. Then the user at the second port 48 can transmit the ciphered text 41 to the first port 38 through the Public Channel 39. After the ciphered text 41 is transmitted to the first port 38, the user at the first port 38 can make use of the decryption module 36 to decrypt the ciphered text 41 with the private key 37 and to realize the contents of the document 42. Similarly, in the process of the transmission of the ciphered text 40 from the first port 38 to the second port 48, if a hacker in the network would like to cut and take the ciphered text 40, the hacker cannot read the concealed contents of the ciphered text 40 whether the hacker obtains the ciphered text 40 or not since the hacker does not have the public key 35. On the other hand, if others also receive the ciphered text 41 in the Public Channel 39, they also cannot read the contents of the ciphered text 41, since the private key for encryption is only owned by the user at the first port 38, Therefore the public key system 30 really can provide the function for secretly delivering the document.

The advantages of the public key system 30 are certainly beyond the above-mentioned advantages. Please refer to FIG. 2 again. The user at the first port 38 of the public key system 30 not only can transmit the public key 35 to the user at the second port 48 in advance, but can also transmit the public key 35 to a third party in advance, even they do not know each other. When the user at the first port 38 would like to transmit the document 32 to the user at the second port 48 and the specific third party, the user at the first port 38 can make use of the above-mentioned procedure to transmit the encrypted document 32, namely the ciphered text 40. The user at the second port 48 and the specific third party can also make use of the above-mentioned procedure to decrypt the ciphered text 40. When the user at the second port 48 and the specific third party would like to deliver another document to the user at the first port 38, the user at the second port 48 and the specific third party can make use of the above-mentioned procedure to encrypt and to transmit the document. After that, the user at the first port 38 can also make use of the above-mentioned procedure to decrypt the encrypted document. Therefore, the transmission of the encrypted document will not only be limited to two parties, which is different from the functions of the private key system.

It is hard to deny that usually the main usage of a ciphering system lies in the guarantee of the safety and concealment of the document during the transmission of the document. However, the identification, integrity, and undeniable character of the document are sometimes more important than the concealment of the document in the applications of business. Please refer to FIG. 2 again. The user at the first port 38 can make use of the private key 37 of his own to sign the document 32 into a signature file through the operations of the encryption module 34, and the user at the second port 48 and the specific third party can convert the signature file into the document 32 through the public key 35. Since only the user at the first port 38 owns the private key 37, only the user at the first port 38 has the capability to sign the document 32 into the signature file, and the others only can identify the signature file without the capability of forging the signature file through the public key 35. Therefore, the signature file, which is legally identical to the personal signature of the user at the first port 38, has the legal effect. In the later days, if there are quarrels (For example, the signer denies his signature), the arbitrational unit as the court can provide sound judgment easily. The ciphering system can also be called the digital signature system. After the letter-sender, such as the user at the first port 38, signs the contract, the letter-accepter, such as the user at the second port 48 or the specific third party, is the person to preserve this contract. The letter-accepter should believe the legal effect of the contract signed with “handwriting”.

Since the public key system contains many above-mentioned advantages and that the need of the privacy system increasingly thrives in the E-Commerce, the public key system gradually becomes the most popular privacy system.

### SUMMARY OF INVENTION

It is therefore a primary objective of the claimed invention to provide a pair of crypto-keys in a network system so that the user can make use of the obtained crypto-keys to encrypt the document.

According to the claimed invention, the network system comprises at least a first user client and an access point with an identifying module and a user list. The access point is used to receive a certificate packet from the first user client and to utilize the identifying module to verify the certificate packet according to the user list so as to generate a verification signal. The network system also comprises a certificate server used to receive the verification signal and to generate a pair of distinct crypto-keys according to the verification signal and a first algorithm. The method for obtaining the pair of crypto-keys comprises utilizing the first user client to generate the certificate packet, utilizing the access point to receive the certificate packet, utilizing the identifying module to verify the certificate packet according to the user list so as to generate the verification signal, and transmitting the verification signal to the certificate server, utilizing the certificate server to generate the pair of distinct crypto-keys according to the first algorithm, controlling the certificate server to transmit the pair of crypto-keys to the access point, and controlling the access point to transmit the pair of crypto-keys to the first client.

Furthermore, after the user obtains the pair of crypto-keys, the user can make use of the pair of crypto-keys to transmit a document after encrypting, and to receive a document decrypted by that pair of crypto-keys.

It is an advantage of the claimed invention that any user who is registered in the user list of the access point in the network system can obtain a pair of crypto-keys through a certificate server. With the pair of crypto-keys, the user can easily encrypt the document and then deliver the document to any place without the needing of worrying about the access of the document by others through the network system. Therefore, concealment of the document can be highly guaranteed in the network system.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of the private key system of the prior art.

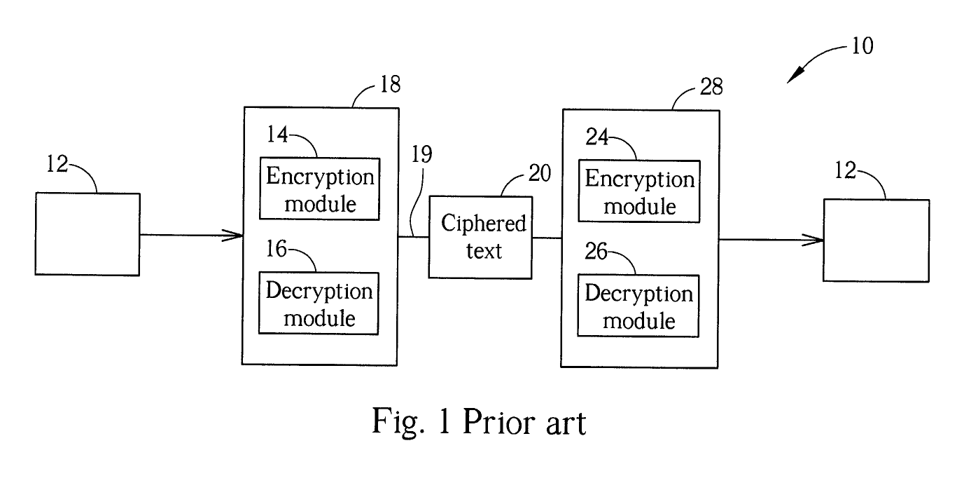

FIG. 2 is a schematic diagram showing how to make use of a public key system to transmit a document.

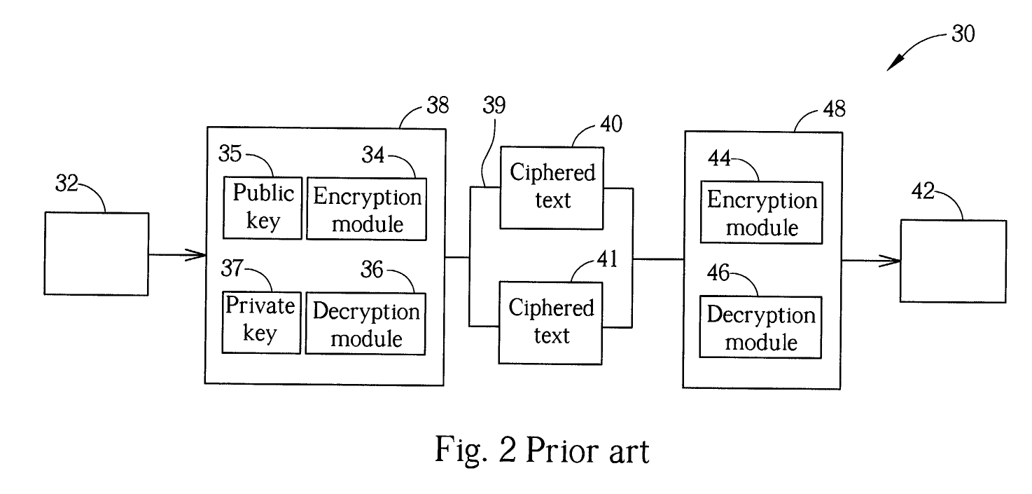

FIG. 3 is a schematic diagram of a network system of the present invention.

FIG. 4 is a flowchart showing that how the user obtains the public key and the private key through a network system of the invention.

FIG. 5 is a flowchart showing the detailed steps in the document-transmitting blocks of FIG. 4.

FIG. 6 is a flowchart showing the detailed steps in the document-receiving blocks of FIG. 4.

FIG. 7 is a flowchart showing the detailed steps in the document-transmitting blocks of FIG. 4 by the hash method.

FIG. 8 is a flowchart showing the detailed steps in the document-receiving blocks of FIG. 4 by the hash method.

### DETAILED DESCRIPTION

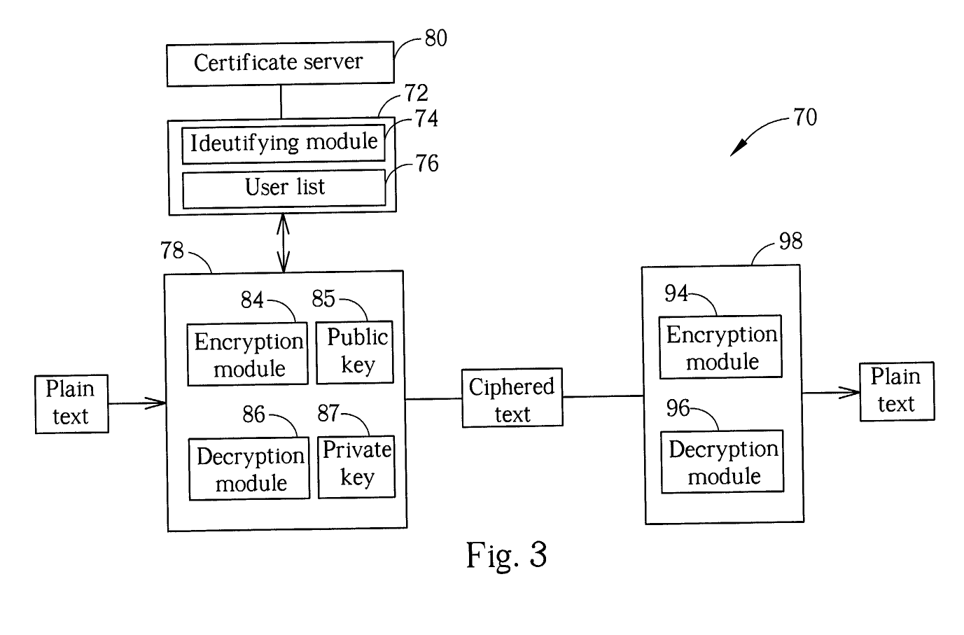

Please refer to FIG. 3. FIG. 3 is a schematic diagram of a network system 70 of the present invention. The network system 70 comprises a first port 78, at least a second port 98, an access point 72 for receiving and transmitting the packet, and a certificate server 80 for generating a distinct pair of crypto-keys with a first algorithm. The pair of crypto-keys comprises a public key 85 and a private key 87. The access point 72 comprises an identifying module 74 for verifying certificate packets transmitted from the first user client 78, and a user list 76 for storing a plurality of user data and the corresponding password data. The first port 78 comprises an encrypting module 84 used to encrypt the document, and a decryption module 86 used to decrypt the document. The second port 98 also comprises an encrypting module 94 and a decryption module 96.

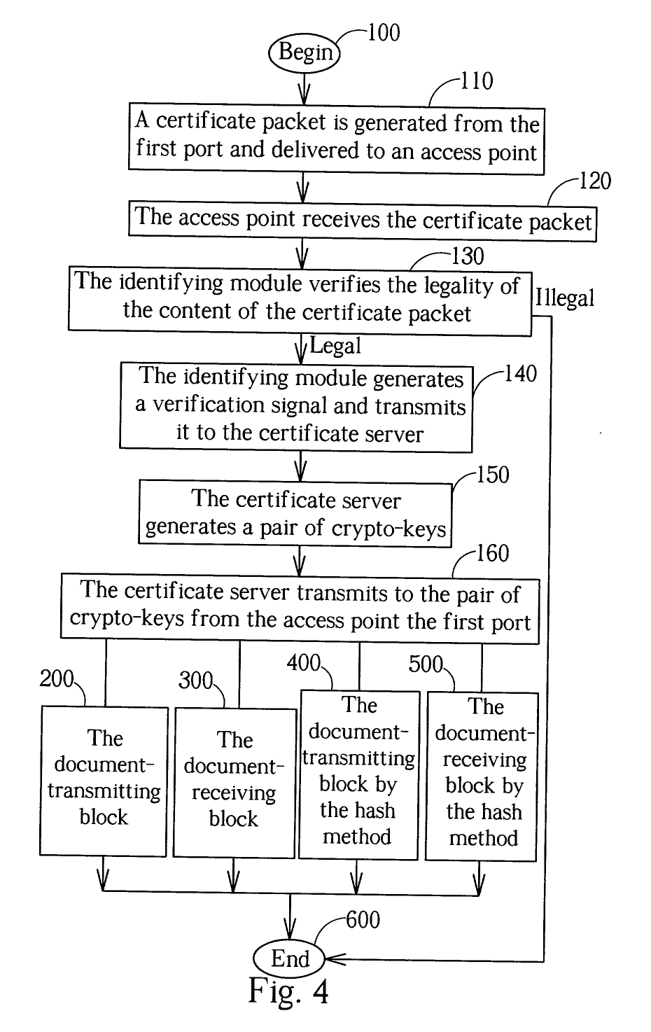

The procedure related to the methods by which how the user at the first port 78 obtains the public key 85 and the private key 87 through the network system 70 is shown in FIG. 4. FIG. 4 is a flowchart showing that how the user obtains the public key and the private key through a network system of the present invention. The instruction of each step is as follows:

Step 100: Begin;

Step 110:

A certificate packet is generated from the first port 78 and delivered to access point 72; (The certificate packet comprises the data related to the name and the password of the user at the first the port 78.)

Step 120: The certificate packet is received by the access point 72;

Step 130:

The content of the certificate packet is verified by the identifying module 74 in the access point 72. If the content is legal, the procedure goes to step 140. If the content is illegal, the procedure goes to step 600; (The identification module 74 in the access point 72 will compare the name data in the certificate packet with the contents of the user list 76 one by one for determining if there exists any name data agreeing with the user list. Then the corresponding password data of the searched name data will be verified if the password data agree with those inside the certificate packet. If these verifications are passed, the user at the first port 78 is verified to be the legally registered consumer of the access port 72.)

Step 140:

A verification signal is generated by the identifying module 74 and transmitted to the certificate server 80;

Step 150:

The certificate server 80 creates a pair of crypto-keys according to the first algorithm; (The certificate server 80 creates a pair of crypto-keys according to the generation of the verification signal.)

Step 160:

The certificate server 80 will transmit the pair of crypto-keys from the access point 72 to the first port 78;

Step 600: End. (If the procedure goes from step 130 directly to this step, the user at the first port 78 is verified not to be the consumer of the network system 70.)

Nowadays, the first algorithm, namely the method for generating the pair of crypto-keys, mentioned in step 150 generally refers to the digital signature algorithm (DSA) or the Rivest-Shamir-Adleman (RAS). Regarding the algorithm of RSA, steps for generating a pair of crypto-keys are described as follows:

1) Find two big prime numbers p and q; (For example p and q both are 128-bit numbers)

2) Calculate the result n=p*q;

3) Take a small odd number e to make e and (p—1)*(q—1) not have a mutual dividing factor larger than 1;

4) Solve the value d wherein de≡1 (mod n);

5) Take (e, n) as the public key 85;

6) Take (d, n) as the private key 87.

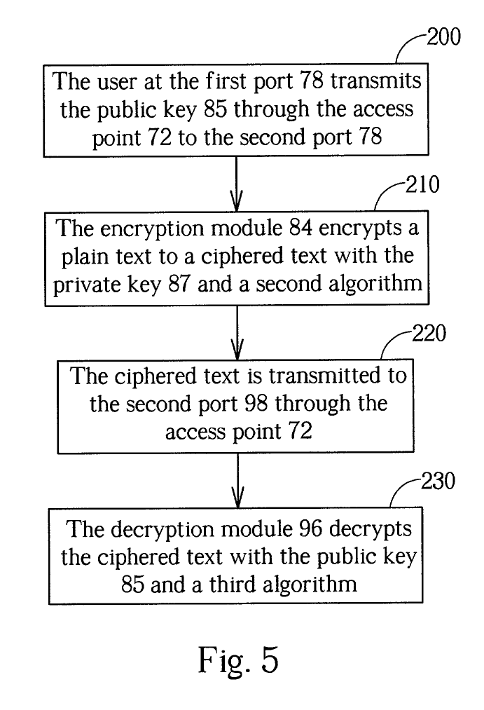

After the user at the first port 78 obtains the pair of crypto-keys, the user can make use of the public key 85 and the private key 87 within the pair of crypto-keys to encrypt the transmitted document. Please refer to FIG. 5. FIG. 5 is a flowchart showing the detailed steps in the document-transmitting blocks of FIG. 4. After the user at the first the port 78 obtains the pair of crypto-keys transmitted from the certificate server 80, the user can make use of the public key 85 and the private key 87 within the pair of crypto-keys to encrypt the document and to transmit the document to the second port 98. The above-mentioned steps are described as follows:

Step 200:

The user at the first port 78 transmits the public key 85 through access point 72 to the second port 98; (The user at the second port 98 can be a friend or stranger to the user at the first port 78.)

Step 210:

The user makes use of the encryption module 84 of the first port 78 to encrypt a plain text to a ciphered text with the private key 87 and a second algorithm; (The second algorithm corresponds to the first algorithm. That is, when the user makes use of the first algorithm to generate the pair of crypto-keys, the user also has to encrypt a document with the second algorithm set by the first algorithm. The concrete example will be mentioned later.)

Step 220:

The user transmits the ciphered text from the first port 78 to the second port 98 through the access point 72; (Since there is no certificate packet transmitted from the first port 78 and the second 98 to the access point 72, the access point 72 will not refuse transmitting the ciphered text from the first 78 to the second port 98.)

Step 230: The user at the second port 98 can make use of the decryption module 96 of the second port 98 to decrypt the ciphered text with the public key 85 and a third algorithm; (The third algorithm also corresponds to the first algorithm. When the user makes use of the first algorithm to generate the pair of crypto-keys the user also has to decrypt the ciphered text with the third algorithm set by the first algorithm.)

The following will explain how the user at the first port 78 makes use of the pair of crypto-keys to encrypt a plain text to a ciphered text with the algorithm of RSA, and how the user at the second port 98 makes use of the pair of crypto-keys to decrypt a ciphered text to a plain text:

The first port 78:

Establish the plain text as M1 (<n), and then set the ciphered text C1=M1\hat{ }d (mod n), wherein (d, n) is the private key 87.

The second port 98:

Establish the ciphered text as C1, and then set the original plain text M1=C1\hat{ }e (mod n), wherein (e, n) is the public key 85.

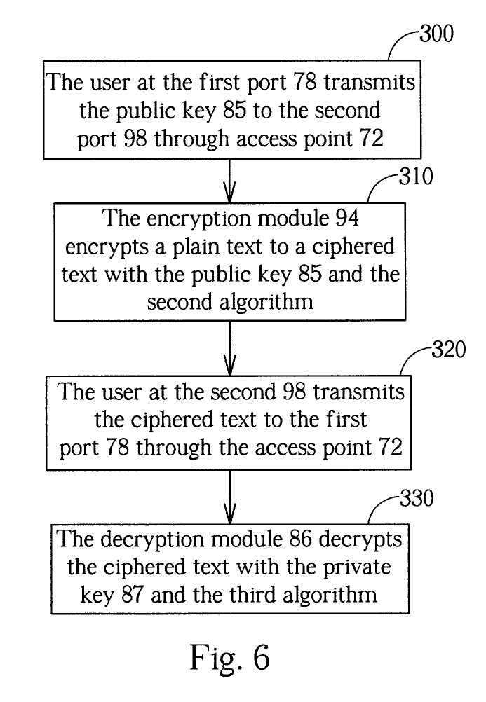

Please refer to FIG. 6. FIG. 6 is a flowchart showing the detailed steps in the document-receiving blocks of FIG. 4. The flowchart shows how the user at the second port 98 makes use of the pair of crypto-keys to deliver the document to the first port 78 after the user at the first the port 78 obtains the pair of crypto-keys transmitted from the certificate server 80. The instruction of each step is as follows:

Step 300:

The user at the first port 78 transmits the public key 85 to the second port 98 through access point 72;

Step 310:

The user at the second port 98 encrypts a plain text to a ciphered text by using the encryption module 94 of the second port 98 with the public key 85 and the second algorithm;

Step 320:

The user at the second 98 transmits the ciphered text to the first port 78 through the access point 72; (Since at this step there is no certificate packet transmitted from the first port 78 and the second 98 to the access point 72, the access ports 72 will not refuse transmitting the ciphered text from the second port 98 to the first port 78.)

Step 330:

The user at the first port 78 makes use of the decryption module 86 to decrypt the ciphered text with the private key 87 and the third algorithm.

Moreover, the following will explain how the user at the first port 78 decrypts the ciphered text transmitted from the second 98 with the above-mentioned algorithm:

The second port 98: Establish the plain text as M2 (<n), and then set the ciphered text C2=M2\hat{ }e (mod n), wherein (e, n) is the public key 85.

The first port 78:

Establish the ciphered text as C2, the then set the original plain text M2=C2\hat{ }d (mod n), wherein (d, n) is the private key 87.

In the algorithm of the public key system, the public key 85 and the private key 87 can be used to provide the function of encryption. If a certain ciphered text is encrypted through the private key 87, the ciphered text can only be decrypted with the public key 85 corresponding to the private key 87. The above-mentioned method is used to generate the digital signature. For example, after the user at the first port 78 in the network system 70 makes use of the private key 87 to encrypt the document, the encrypted document becomes the digital signature of the user at the first port 78. Afterwards, the user at the first port 78 transmits the digital signature to the second port 98, and the user at the second port 98 makes use of the public key 85 transmitted from the first port 78 to verify the signature attached on the encrypted document and to decrypt the ciphered document.

However, sometimes it is lacking of efficiency to use the private key 87 to encrypt the whole document. We can replace encrypting the whole document by only signing the hash of the document:

1) The first port 78 first calculates a one-way hash of the document with a fourth algorithm;

2) The user at the first port 78 makes use of the private key to encrypt the one way hash, and the encrypted first hash becomes the signature of the document;

3) The user at the first port 78 transmits both the document and the signature to the second port 98;

4) The user at the second port 98 makes use of the public key 85 transmitted from the first port 78 to decrypt the signature of the document, that is, to decrypt the encrypted one-way hash, and the user at the second port makes use of the fourth algorithm to convert the document transmitted from the first port 78 into a second hash. After that, compare the decrypted first hash with the second hash. If these two values are the same, the following two matters can be verified:

a) That document is really transmitted from the first port 78;

b) That document is never distorted in the transmitting process.

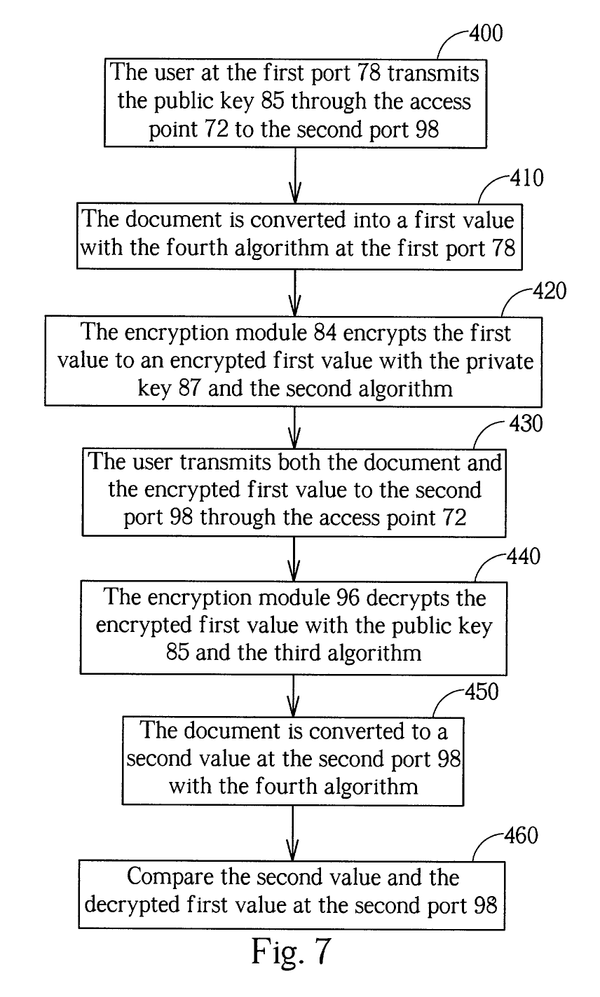

Please refer to FIG. 7. FIG. 7 is a flowchart showing the detailed steps in the document-transmitting blocks of FIG. 4 by the hash method. The flowchart shows that after the user at the first the port 78 obtains the public key 85 and the private key 87 transmitted from the certificate server 80, how the user at the first port 78 delivers a document to the user at the second port 98. The instruction of each step is as follows:

Step 400:

The user at the first port 78 transmits the public key 85 through the access point 72 to the second port 98;

Step 410:

The document is converted into a first value with the fourth algorithm at the first port 78;

Step 420:

The user at the first port 78 makes use of the encryption module 84 of the first port 78 to encrypt the first value to an encrypted first value with the private key 87 and the second algorithm mentioned in step 210;

Step 430:

The user at the first port 78 transmits both the document and the encrypted first value to the user at the second port 98 through the access point 72;

Step 440:

The user at the second port 98 makes use of the encryption module 96 of the second port 98 to decrypt the encrypted first value to a decrypted first value with the public key 85 and the third algorithm mentioned in step 230;

Step 450:

The user at the second port 98 makes use of the fourth algorithm to convert the document into a second value;

Step 460:

Compare the second value and the decrypted first value at the second port 98; (If the second value is equal to the decrypted first value, the document is verified to be really transmitted from the first port 78 and not to be distorted in transmitting process.)

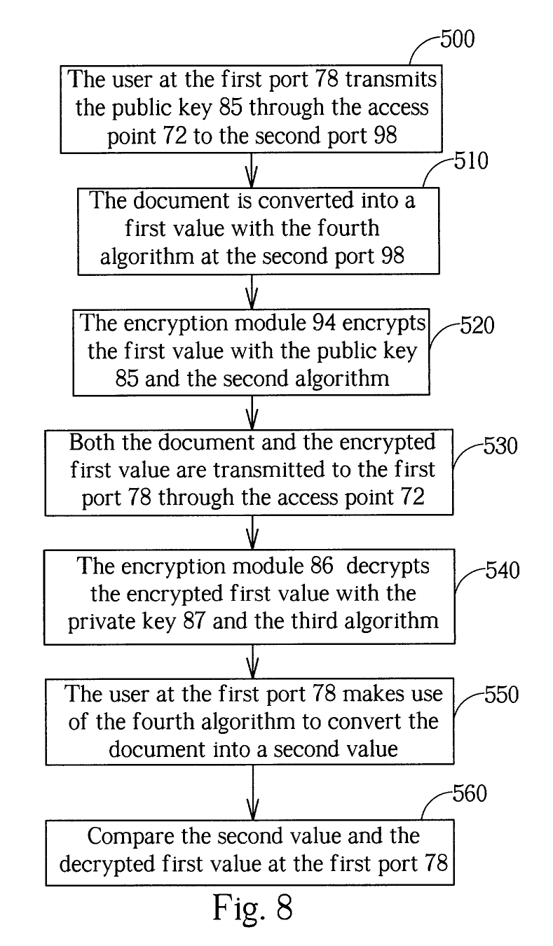

Please refer to FIG. 8. FIG. 8 is a flowchart showing the detailed steps in the document-receiving blocks of FIG. 4 by the hash method. The flowchart shows that after the user at the first the port 78 obtains the public key 85 and the private key 87 transmitted from the certificate server 80, how the user at the first port 78 receives a document from the user at the second port 98. The instruction of each step is as follows:

Step 500:

The user at the first port 78 transmits the public key 85 through the access point 72 to the second port 98;

Step 510:

The document is converted into a first value with the fourth algorithm at the second port 98;

Step 520:

The user at the second port 98 makes use of the encryption module 94 of the second port 98 to encrypt the first value to an encrypted first value with the public key 85 and the second algorithm;

Step 530:

The user at the second port 98 transmits both the document and the encrypted first value to the user at the first port 78 through the access point 72;

Step 540:

The user at the first port 78 makes use of the encryption module 86 of the first port 78 to decrypt the encrypted first value to a decrypted first value with the private key 87 and the third algorithm;

Step 550:

The user at the first port 78 makes use of the fourth algorithm to convert the document into a second value;

Step 560:

Compare the second value and the decrypted first value at the first port 78; (If the second value is equal to the decrypted first value, the document is verified to be really transmitted from the second port 98 and not to be distorted in transmitting process.)

Generally the hash algorithm includes the message-digest algorithm (MD2), MDS, the secure Hash algorithm (SHA1), and so on.

In contrast to the prior art, the advantage of the present invention is that any user, who is registered in the user list of the access point in the network system, can obtain a pair of crypto-keys through a certificate server. With the pair of crypto-keys, the user can easily encrypt the document and then deliver the document to any place without the needing of worrying about the access of the document by others through the network system. Therefore, concealment of the document can be highly guaranteed in the network system. Furthermore, if the user client usually has to deal with lots of data, the encryption module and decryption module of the user client also can replace the software structure with the hardware structure.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for applying for crypto-keys from a network system, the network system comprising at least a first user client, an access point having an identifying module and a user list, and a certificate server, the access point being used to receive a certificate packet from the first user client and to utilize the identifying module to verify the certificate packet according to the user list so as to generate a verification signal, the certificate server being used to generate a pair of distinct crypto-keys according to the verification signal and a first algorithm, the method comprising:
utilizing the first user client to generating the certificate packet;
utilizing the access point to receive the certificate packet;
utilizing the identifying module to verify the certificate packet according to the user list so as to generate the verification signal, and transmitting the verification signal to the certificate server;
utilizing the certificate server to generate the pair of distinct crypto-keys according to the first algorithm;
controlling the certificate server to transmit the pair of crypto-keys to the access point; and
controlling the access point to transmit the pair of crypto-keys to the first client.

2. The method of claim 1 wherein the certificate packet comprises a user name and a password.

3. The method of claim 1 wherein the first algorithm is a Rivest Shamir Asleman (RSA) algorithm.

4. The method of claim 1 wherein the first algorithm is a digital signature algorithm (DSA).

5. The method of claim 1 wherein the pair of crypto-keys is a public key and a private key.

6. The method of claim 1 wherein the network system further comprises at least a second user client communicating with the access point, and the first user client comprises a first encryption module for encrypting a plain text into a ciphered text according to a second algorithm and a first key of the pair of crypto-keys, the second user client comprises a second decryption module for decrypting the ciphered text into the plain text according to a third algorithm and a second key of the pair of crypto-keys, the method further comprising:
transmitting the second key from the first user client through the access point to the second user client;
utilizing the first encryption module to encrypt the plain text into the cipher text according to the second algorithm and the first key;
transmitting the ciphered text from the first user client through the access point to the second user client; and
utilizing the second decryption module to decrypt the ciphered text according to the third algorithm and the second key.

7. The method of claim 6 wherein the second algorithm and third algorithm are associated with the first algorithm.

8. The method of claim 6 wherein the first user client further-comprises a first decryption module for decrypting the ciphered text into the plain text according to the third algorithm and the first key, and the second user client further comprises a second encryption module for encrypting the plain text into the ciphered text according to the second algorithm and the second key, the method further comprising:
utilizing the second encryption module to encrypt the plain text into the ciphered text according to the second algorithm and the second key;
transmitting the from the second user client through the access point to the first user client; and
utilizing the first decryption module to decrypt the ciphered text according to the third algorithm and the first key.

9. The method of claim 1 wherein the network system further comprises at least a second user client communicating with the access point, and the first user client comprises a first encryption module for encrypting numbers according to a second algorithm and a first key of the pair of crypto-keys, the second user client comprises a second decryption module for decrypting numbers according to a third algorithm and a second key of the pair of crypto-keys, the method further comprising:
transmitting the second key from the first user client through the access point to the second user client;
controlling the first user client to convert a plain text into a first value according to a fourth algorithm;
utilizing the first encryption module to encrypt the first value according to the second algorithm and the first key;
transmitting the and the encrypted first value from the first user client through the access point to the second user client;
utilizing the second decryption module to decrypt the encrypted first value according to the third algorithm and the second key;
controlling the second user client to convert the plain text into a second value according to the fourth algorithm; and
comparing the second value with the decrypted first value to verify the plain text transmitted from the first user client to the second user client.

10. The method of claim 9 wherein the fourth algorithm is a message digest 2 (MD2) algorithm.

11. The method of claim 9 wherein the fourth algorithm is a message digest 5 (MD5) algorithm.

12. The method of claim 9 wherein the fourth algorithm is a secure Hash algorithm (SHA).

13. The method of claim 9 wherein the second algorithm and third algorithm are associated with the first algorithm.

14. The method of claim 9 wherein the first user client further comprises a first decryption module for decrypting numbers according to the third algorithm and the first key, and the second user client further comprises a second encryption module for encrypting numbers according to the second algorithm and the second key, the method further comprising:
controlling the second user client to convert the plain text to the first value according to the fourth algorithm;
utilizing the second encryption module to encrypt the first value according to the second algorithm and the second key;
transmitting the and the encrypted first value from the second user client through the access point to the first user client;
utilizing the first decryption module to decrypt the encrypted first value according to the third algorithm and the first key;
controlling the first user client to convert the forth algorithm; and
comparing the second value with the decrypted first value to verify the plain text transmitted from the second user client to the first user client.
